(19) United States
(12) Patent Application Publication
(10) Pub. No.: US 2025/0100323 A1
(43) Pub. Date: Mar. 27, 2025

(54) Method for Feathering Paper

(71) Applicant: Daniel Aaron Huffman, Quitman, TX (US)

(72) Inventor: Daniel Aaron Huffman, Quitman, TX (US)

(21) Appl. No.: 18/625,049

(22) Filed: Apr. 2, 2024

(51) Int. Cl. B44D 5/10; D21H 27/02

(52) U.S. Cl. CPC B44D 5/10; D21H 27/02

(57) ABSTRACT

This invention can be made for public use or commercial and programmed or re-programmed for editing, feathering, and printing any photograph or picture, letters, numbers, or symbols or old photographs or pictures to make them color if they are in black and white or old-timey colored for new photographs to be feathered into a final product that can be felt in 3D with various (length, width, depth and height) to the touch to make the experience more personal such as with wedding photographs, military photographs or fallen heroes, graduation photographs, civil service photographs, corporate photographs, or any photograph that has special meaning to the owner and may be incorporate for pictures not limited to photographs, greeting cards, sports cards, graphic novels, gift bags, consumer product packaging, stationary, comic books, letters, numbers and symbols and any other product made with paper.

### BRIEF DESCRIPTION OF DRAWINGS

The drawings show the process for feathering paper of any (length, width, depth and height) not limited to photographs and pictures used on greeting cards, sports cards, graphic novels, gift bags, consumer product packaging, stationary, comic books, letters, numbers and symbols and any other product made with paper as well as the machine example that can be made for personal use or commercial use and may be adjusted for small or large printing projects.

### DESCRIPTION OF FIGURES

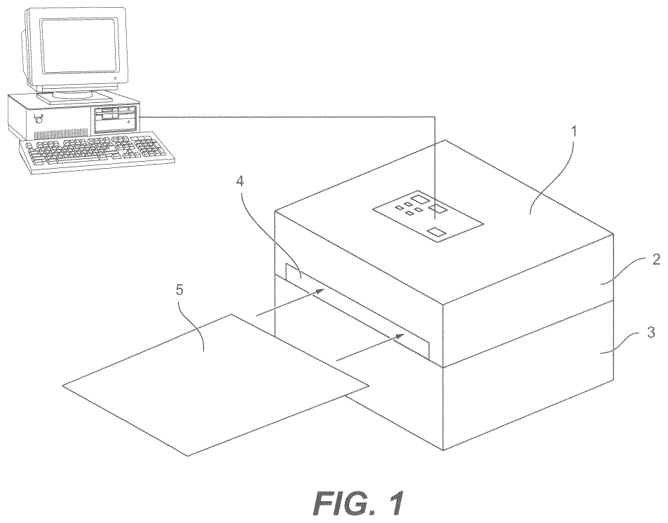

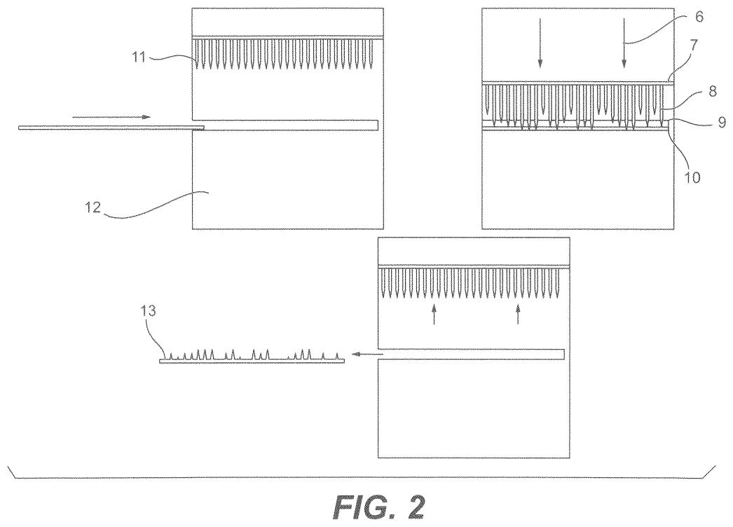

FIG. 1 (Number 1) is the computer software for the machine for feathering photographs or pictures in 3D for various length, width, depth or height of the paper. This can be programmed to highlight the picture or photograph on the computer in different areas to select the length, width, depth and height of the feathering on the paper before the final ink is applied. The photographs can be made to look old-fashioned if new, to look new in color if black and white or a variety of different ways by using software for editing the photograph or picture before the feathering. This machine can be used to feather and then ink as many copies that are needed for each picture or photograph when the product is finished being created or edited on the computer software program. (Number 2) see FIG. 2 for detailed description. The paper can be inserted face up for the feathering and then the ink applied after the feathering process. The front of the paper not feathered for greeting cards or other paper can be inked with the words, letters, numbers and symbols without feathering as well above or below the feathered picture. The paper can vary in thickness, length and width for different depth and height. The bottom of the paper not feathered can be printed on as well by double sided printing for greeting cards that need to be folded after feathering and printing. (Number 3) houses the hard surface for the hard metal or steel needles to feather the paper when inserted into (Number 4) slot and the needles of Figure 2 feather the paper to the desired length, width, depth and height. After the paper has been feathered from the initial insertion into the machine it can be inked automatically by the machine pulling it through to the last part of the machine (the back) where it can be printed on one side or both if desired without feathering the bottom (omitted). The finished product comes out the back of the machine where a tray is ready to catch it (omitted). The front of the machine can be loaded with many pieces of paper needed for reproduction (omitted). (Number 3) can be used for the storage of paper for the feathering process as well in different sizes. (Number 5) can be any size paper that needs to be used for feathering and printing.

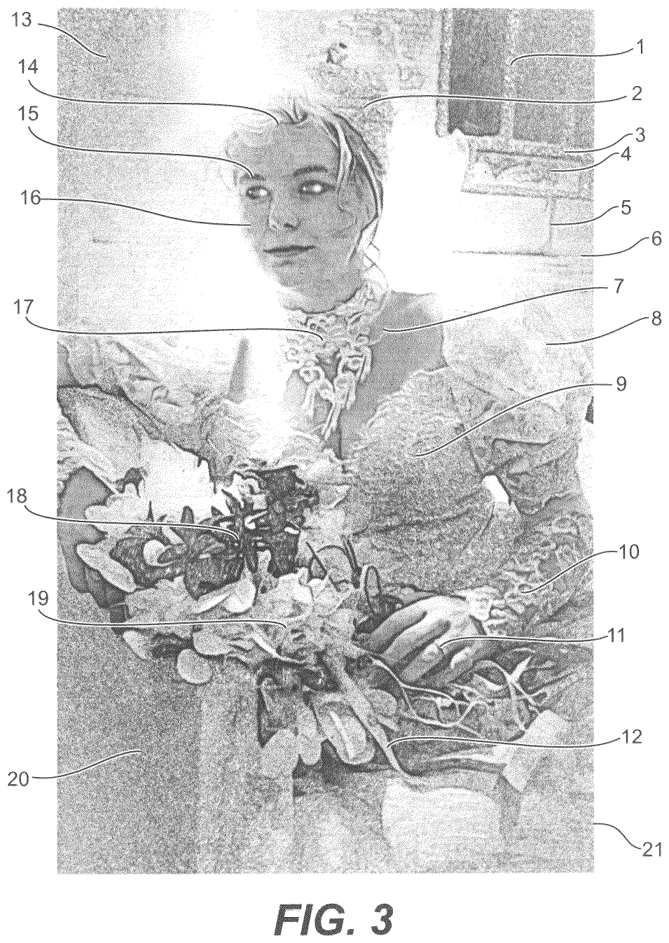

FIG. 2 is the process for feathering the paper no matter the length, width, depth or height. The process can make any part of the photograph or picture thicker in some parts and not so thick in others or no feathering at all such as skin. The different thickness makes the photograph or picture feel real like 3D and appeals to the eye and the touch especially for military families who have lost their Heroes. The touch appeals to the senses and makes them feel closer to the one they lost. The same is for wedding photographs and graduation, births and any photograph important to that person. (Number 6) shows the pressure applied to the individual needles spaced millimeters apart that can be applied with compressed air, hydraulics, electricity or whatever can be used to apply pressure to the needles. The pressure varies based upon the highlighting of the photograph or picture, letters, numbers, or symbols from the software of the computer. Some needles will feather deeper for a higher height to the touch and some may feather less with less pressure for a less 3D feel on the same photograph or picture so the picture or photograph feel different in many places. Skin is never feathered or eyes. This is also described in greater detail in FIGS. 3-8. (Number 7) The steel needles are housed millimeters apart and different pressure is applied to each needle for greater or lesser depth and height, length and width for the photograph or picture from (Number 6) by hydraulic, compressed gases or electricity. The needles can be added or subtracted from the housing if need be and vary by number. The width of (number 7) and height can vary for the housing of the needles because once the needles feather the paper automatic air or compressed air or gas from electricity is forced from automatic fans within the (number 7 omitted) it blows off the debris from the paper before inked. (Number 8) shows the needle which has to be hard metal or steel and can vary in size but best to be 0.5 inch to 1 inch long and wide enough not to break such as a push pin but the width can vary within reason. The individual needles can plunge deeper into the paper or less deep for different feathering techniques for photographs, pictures, letters, numbers, and symbols. (Number 9) is the paper being feathered for photographs, pictures (greeting cards, comic books, post cards, trading cards, sports cards, graphic novels or any picture using paper), letters, numbers, or symbols. (Number 10) is the hard surface for the needle points to have resistance for the feathering of the paper on top of the hard surface. (Number 11) shows how the needle points are frailed like sand paper to pluck the paper all over to feather the paper when each millimeter of the paper is totally feathered all over for the final 3D image to be inked. (Number 11) also shows the space between the needle points that can be angled up to 8 degrees (more or less) for maximum feathering in the housing of the needles in (Number 11 in FIG. 1). (Number 12) shows where the paper is inserted into the machine on the hard surface of (Number 12) for feathering the paper. (Number 13) shows the paper feathered in different proportions for the maximum 3D feel to also maximize the viewing experience. One can touch the picture or photograph, letters, numbers, or symbols as they are viewing it. It makes it more personal and effects the senses and brings back memories for special memories, boyfriends and girlfriends, weddings, military service, graduations or anything appealing to the senses.

FIG. 3 shows the wedding photo of my wife and is numbered according to the different depths and heights, length and width (8×10) of the photograph. Any size photograph can be feathered for a 3D effect. (Number 1) shows the housing for the stained glass window of the church and is feathered at a thicker height like (Numbers 3, 4,5,6,10,11,16, 17) than (Numbers 2, 8, 9, 12, 13,19,20,21). (Number 14) for the hair is a thicker height than (Number 15) and falls in curls to the right of her face than for the eyebrows. Finally, (Number 7) for the skin has no feathering whatsoever for the entire photograph.

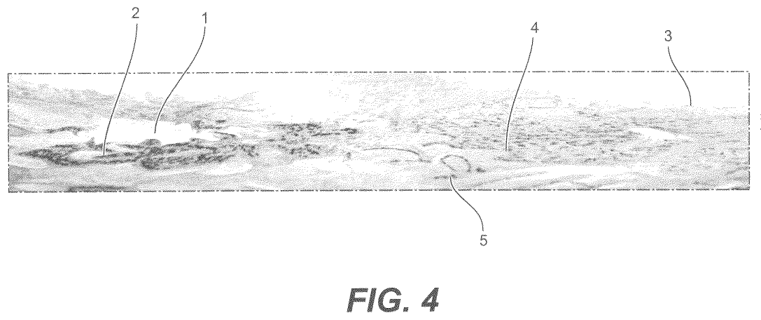

FIG. 4 reiterates the feathering of different depth and height of the paper's length and width (8×10) for (Numbers 1-5). It is a flat image showing the different featherings of the photograph as described and illustrated in FIG. 3. Any photograph can be done like this on cardstock and white color is the best for feathering because when the ink is applied to white it is very vibrant. Any size and thickness* of paper can be used to be feathered. It is best to use a minimum thickness of cardstock for the paper or thicker.

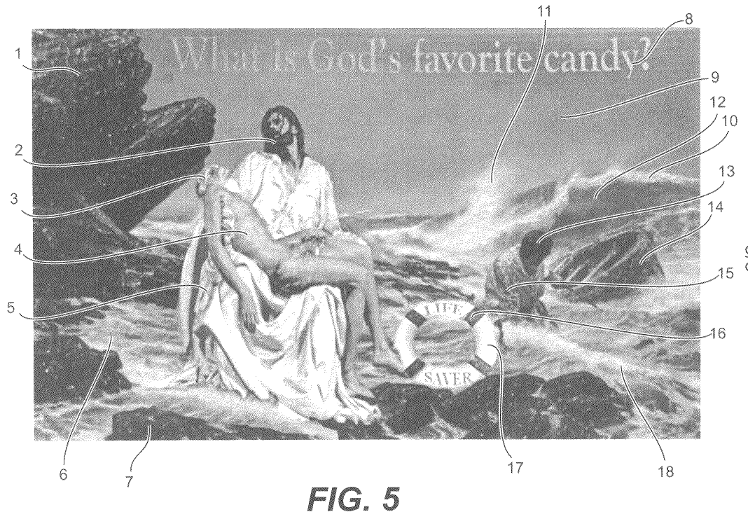

FIG. 5 shows an example of a greeting card with letters and different feathering within the image. (Numbers 1 and 7) show the image of the rocks which are feathered thicker (height) like (Number 2, 3 and 14). (Numbers 11 and 18) for the waves are feathered thicker than the waters of (Number 6) for example. The clothes for (Numbers 5 and 15). (Numbers 4, 9, 12, and 16) are not feathered at all to give the paper the depth feel of the 3D effect. (Number 8) is feathered thick for the letters and symbol but in between the letters is not feathered at all for depth. (Number 17) is also feathered less thick (height) than (Number 8) with the words LIFE SAVER un-feathered.

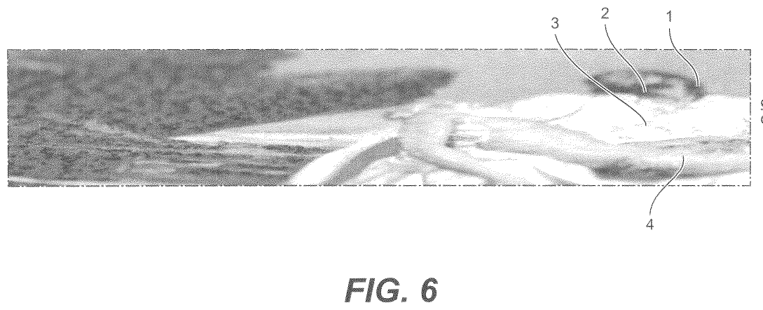

FIG. 6 shows the same view as FIG. 4 with (Numbers 1-4) just showing how there is different depth and height in the feathering of the paper for the 4×6 length and width of the paper.

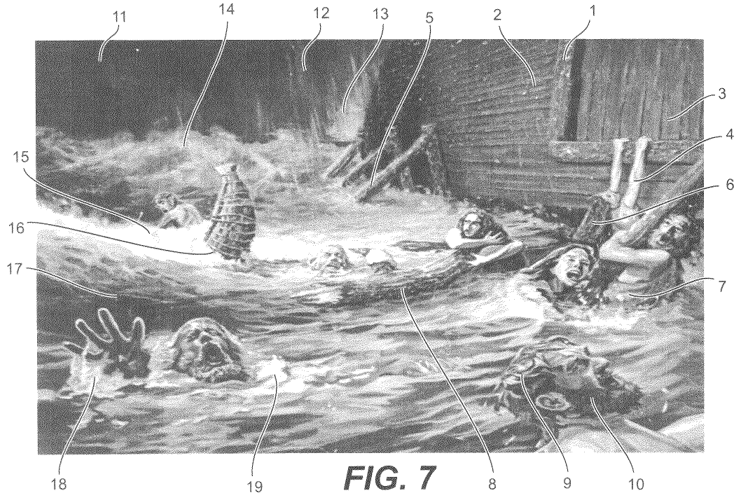

FIG. 7 shows the example of a post card, graphic novel, greeting card or comic book paper page feathered. (Number 1) is thick wood feathered thicker than any part of Noah's Ark and feathered to make it look rough and old and beaten up for greater 3D visual effect and touch sense effect. (Number 2) only the lines of the wooden planks are feathered and the mass of the wooden planks are not feathered at all so the ship feels real to the touch and is life-like. The same is shown in (Number 3) as (Number 2). The skin of lost (Number 4) is not feathered at all for realism and is the same for all skin because skin is not feathered but smooth. The wood for (Numbers 5 and 8) are feathered heavy as they are logs. The hair for the Lost (Numbers 6, 9, and 10) are feathered medium for realism to the touch. (Numbers 13, 14, 15, 18 and 19) are heavy waves feathered with greater height than (Number 17) representing the entire dark water which has no feathering at all for added depth to offset the height of the white waves and water. (Number 11) is the night sky which is not feathered at all for depth perspective. (Number 12) is the rainfall which is feathered lightly to medium, to heavy throughout the picture for added height and depth to the touch and realism. (Number 16) fruit basket has each line outlining the basket feathered as well but not the interior of the lines for realistic feel of the basket.

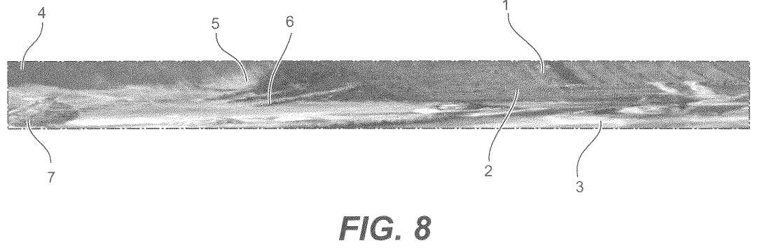

FIG. 8 and (Numbers 1-7) show the different depths and height of the feathering process for the picture.

1. This invention allows anything made with paper to be feathered into a 3D effect not limited to photographs, greeting cards, sports cards, graphic novels, gift bags, consumer product packaging, stationary, comic books, letters, numbers and symbols and any other product made with paper.

2. This invention allows various photographs, pictures, letters, numbers, and symbols to be feathered on paper of various sizes and thickness and the length, width, depth and height of the feathering to vary to the desired result for each component of the photograph or picture, letters, numbers, or symbols for a 3D feel that is appealing to the touch as well as the eyes.

3. This invention can be made for public use or commercial and programmed or re-programmed for editing, feathering, and printing any photograph or picture, letters, numbers, or symbols or old photographs or pictures to make them color if they are in black and white or old-timey colored for new photographs to be feathered into a final product that can be felt in 3D with various (length, width, depth and height) to the touch to make the experience more personal such as with wedding photographs, military photographs or fallen heroes, graduation photographs, civil service photographs, corporate photographs, or any photograph that has special meaning to the owner and may be incorporate for pictures not limited to photographs, greeting cards, sports cards, graphic novels, gift bags, consumer product packaging, stationary, comic books, letters, numbers and symbols and any other product made with paper.
